(19) United States
(12) Patent Application Publication
(10) Pub. No.: US 2025/0296897 A1
(43) Pub. Date: Sep. 25, 2025

(54) MICROBE DISPENSING DEVICE FOR A COMPOSTING SYSTEM

(71) Applicant: Haier US Appliance Solutions, Inc., Wilmington, DE (US)

(72) Inventors: Jacob Frank, Louisville, KY (US); Alexander Rielage, Cincinnati, OH (US)

(21) Appl. No.: 18/613,881

(22) Filed: Mar. 22, 2024

(51) Int. Cl. C05F 17/971; C05F 17/20; C05F 17/50; C05F 17/70; C05F 17/95; C05F 17/986; C05F 17/993

(52) U.S. Cl. CPC C05F 17/971; C05F 17/20; C05F 17/50; C05F 17/70; C05F 17/95; C05F 17/986; C05F 17/993

(57) ABSTRACT

A composting machine includes a fermentation reservoir for holding anaerobic waste and a microbe dispensing device positioned at least partially above the fermentation reservoir. The microbe dispensing device includes a microbe reservoir for receiving a microbe product and a dispensing mechanism for selectively depositing the microbe product into the fermentation reservoir to facilitate a fermentation process of the anaerobic waste.

### FIELD OF THE INVENTION

The present subject matter relates generally to waste management systems, and more particularly to composting systems that include microbe dispensers for facilitating an anaerobic composting process.

### BACKGROUND OF THE INVENTION

Landfills are commonly used sites for disposing of waste materials or garbage generated by humans. For example, trash collection systems typically collect waste from residential and commercial locations and transport that waste to landfills, where it is dumped and covered with dirt. Notably, food waste that is collected and deposited in a landfill undergoes an anaerobic decomposition process due to the lack of oxygen and can thus produce methane. Removing this food waste from the waste materials dumped in a landfill may significantly reduce the generation of methane, which is a very harmful greenhouse gas that is not environmentally friendly and may lead to global warming.

Moreover, food waste may be composted to provide useful soil and fertilizer for improved plant growth. However, conventional composting systems are burdensome and inefficient. For example, conventional composting techniques require dosing with microbes to catalyze a fermentation reaction to break down certain waste products, such as meat, bones, and dairy products. However, in current designs, these microbes are hand measured and dispersed by the user, which can lead to over/under dosing, inconsistent inclusion in the chamber, and inconsistent results in their composting. Moreover, conventional methods of dispensing microbes introduce large amounts of oxygen into the composting system, which may be undesirable for an anaerobic composting process.

Accordingly, a composting system that ensures accurate and repeatable dosing of microbes to facilitate a composting process is desirable. More specifically, a composting system that may store a large amount of microbes and consistently and automatically dispense them without introducing undesirable amounts of oxygen would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a composting machine is provided including a fermentation reservoir for holding anaerobic waste and a microbe dispensing device positioned at least partially above the fermentation reservoir. The microbe dispensing device includes a microbe reservoir for receiving a microbe product and a dispensing mechanism for selectively depositing the microbe product into the fermentation reservoir to facilitate a fermentation process of the anaerobic waste.

In another exemplary embodiment, a microbe dispensing device for a composting machine is provided. The microbe dispensing device includes a microbe reservoir positioned at least partially above a fermentation reservoir and being configured for receiving a microbe product and a dispensing mechanism for selectively depositing the microbe product into the fermentation reservoir to facilitate a fermentation process of anaerobic waste in the fermentation reservoir.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a composting system according to an example embodiment of the present subject matter.

FIG. 2 provides a top, perspective view of waste reservoirs of the example composting system of FIG. 1 according to an example embodiment of the present subject matter.

FIG. 3 provides a bottom, perspective view of the example waste reservoirs of FIG. 2 according to an example embodiment of the present subject matter.

FIG. 4 provides a top, perspective view of a fermentation reservoir and a composting reservoir of the example composting system of FIG. 1 according to an example embodiment of the present subject matter.

FIG. 5 provides a top, perspective view of a microbe dispensing device of the example composting system of FIG. 1 according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

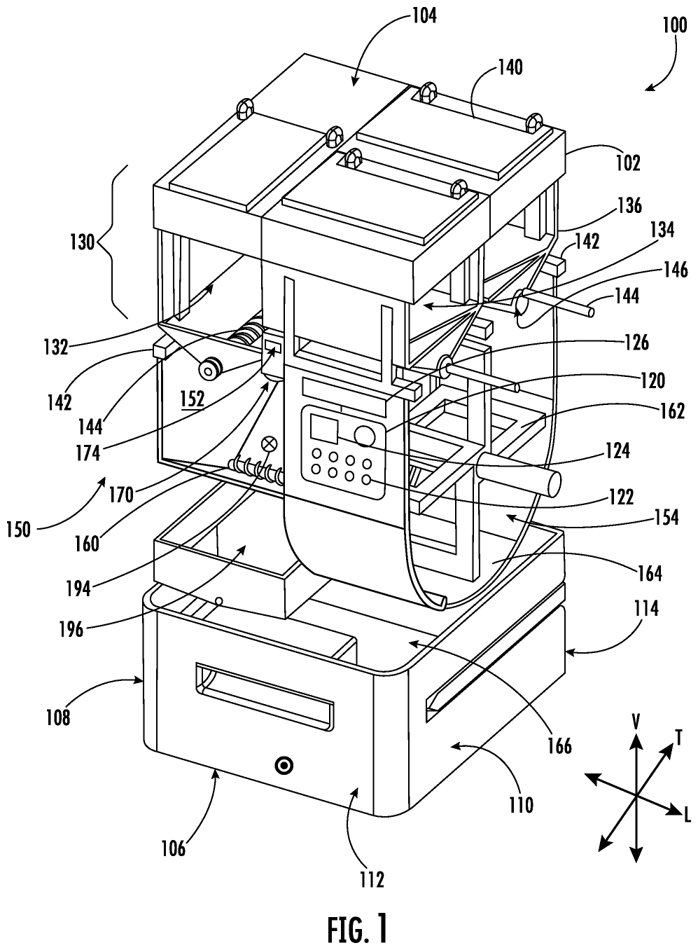

Turning to the figures, FIG. 1 provides a perspective view of a composting machine 100 according to an exemplary embodiment of the present disclosure. As explained in more detail below, composting machine 100 may be used in any residential, commercial, or other setting for improving the disposal of liquid and food waste. More specifically, the composting machine 100 described herein provides for environmentally friendly waste disposal of both anaerobic and aerobic waste. Moreover, byproducts of food waste may be used for secondary beneficial purposes, such as being used as compost, fertilizer, mulch, or other organic planting material.

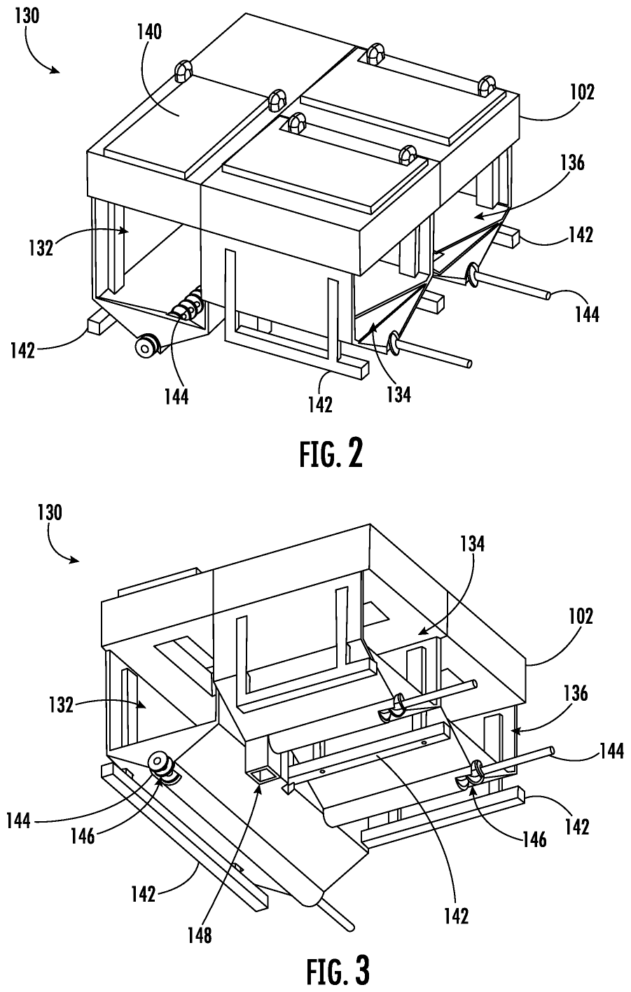

As illustrated, composting machine 100 generally defines a vertical direction V, a lateral direction L, and a transverse direction T, each of which is mutually perpendicular, such that an orthogonal coordinate system is generally defined. According to exemplary embodiments, composting machine 100 includes a cabinet 102 (partially illustrated at top of machine in FIGS. 1 through 3) that is generally configured for containing and/or supporting various components of composting machine 100 and which may also define one or more internal chambers or compartments of composting machine 100.

In this regard, as used herein, the terms “cabinet,” “housing,” and the like are generally intended to refer to an outer frame or support structure for composting machine 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of composting machine 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing composting machine 100.

Referring again to FIG. 1, composting machine 100 may include a control panel 120 that may represent a general-purpose Input/Output (“GPIO”) device or functional block for composting machine 100. In some embodiments, control panel 120 may include or be in operative communication with one or more user input devices 122, such as one or more of a variety of digital, analog, electrical, mechanical, or electro-mechanical input devices including rotary dials, control knobs, push buttons, toggle switches, selector switches, and touch pads. Additionally, composting machine 100 may include a display 124, such as a digital or analog display device generally configured to provide visual feedback regarding the operation of composting machine 100. For example, display 124 may be provided on control panel 120 and may include one or more status lights, screens, or visible indicators. According to exemplary embodiments, user input devices 122 and display 124 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Composting machine 100 may further include or be in operative communication with a processing device or a controller 126 that may be generally configured to facilitate appliance operation. In this regard, control panel 120, user input devices 122, and display 124 may be in communication with controller 126 such that controller 126 may receive control inputs from user input devices 122, may display information using display 124, and may otherwise regulate operation of composting machine 100. For example, signals generated by controller 126 may operate composting machine 100, including any or all system components, subsystems, or interconnected devices, in response to the position of user input devices 122 and other control commands. Control panel 120 and other components of composting machine 100 may be in communication with controller 126 via, for example, one or more signal lines or shared communication busses. In this manner, Input/Output (“I/O”) signals may be routed between controller 126 and various operational components of composting machine 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 126 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 126 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 126 may be operable to execute programming instructions or micro-control code associated with an operating cycle of composting machine 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 126 as disclosed herein is capable of and may be operable to perform any methods, method steps, or portions of methods as disclosed herein. For example, in some embodiments, methods disclosed herein may be embodied in programming instructions stored in the memory and executed by controller 126.

The memory devices may also store data that can be retrieved, manipulated, created, or stored by the one or more processors or portions of controller 126. The data can include, for instance, data to facilitate performance of methods described herein. The data can be stored locally (e.g., on controller 126) in one or more databases and/or may be split up so that the data is stored in multiple locations. In addition, or alternatively, the one or more database(s) can be connected to controller 126 through any suitable network(s), such as through a high bandwidth local area network (LAN) or wide area network (WAN). In this regard, for example, controller 126 may further include a communication module or interface that may be used to communicate with one or more other component(s) of composting machine 100, controller 126, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Referring now specifically to FIGS. 1 through 3, composting machine 100 may generally include a waste receiving portion 130 positioned proximate top 104 of cabinet 102. In general, waste receiving portion 130 may include one or more reservoirs into which a user may deposit various waste products for a subsequent composting process. Specifically, according to the illustrated embodiment, waste receiving portion 130 may include an anaerobic waste reservoir 132 which is generally configured for receiving anaerobic waste, a green waste reservoir 134 which is generally configured for receiving green waste, and an aerobic waste reservoir 136 which is generally configured for receiving aerobic waste, as will be described in more detail below.

As used herein, the term “anaerobic waste” may generally refer to any waste, trash, or other materials placed into composting machine 100 which should be broken down or composted using an anaerobic process, i.e., a process performed in the absence of oxygen or with a minimal amount of oxygen. Anaerobic waste may include raw or cooked meat, bones, dairy products, or other waste that may contain or generate food-borne pathogens. As used herein, the term “green waste” may generally refer to vegetables, starches, breads, or other materials that may be composted either in the presence of oxygen or in the absence of oxygen. As used herein, the term “aerobic waste” may generally refer to any waste, trash, or other materials placed into composting machine 100 which may be broken down or composted using an aerobic process, i.e., a process performed with oxygen present. Aerobic waste may include paper, cardboard, other non-organic materials, etc.

According to the illustrated embodiment, waste receiving portion 130 may include a plurality of doors 140 that are pivotally mounted to cabinet 102 for providing selective access to anaerobic waste reservoir 132, green waste reservoir 134, and aerobic waste reservoir 136, respectively. According to an example embodiment, waste may be loaded into respective reservoirs 132-136 until the total weight of composting material reaches a desired threshold to facilitate a composting process. In this regard, each of anaerobic waste reservoir 132, green waste reservoir 134, and aerobic waste reservoir 136 may be supported by weight sensing bars 142 that are connected to cabinet 102 and include one or more load cells (not shown) for detecting the weight within each reservoir 132-136.

According to the illustrated embodiment, waste receiving portion 130 may further include a plurality of augers 144 for selectively grinding, macerating, and/or depositing the material from each reservoir 132-136 into a composting portion 150 of composting machine 100 (described below). In this regard, for example, when a target weight of composting material is received within each reservoir 132-136, augers 144 may be selectively rotated to grind and dispense the material from the respective reservoirs 132-136 into composting portion 150 of composting machine 100 where composting processes may take place. For example, each reservoir 132-136 may define a discharge aperture 146 through which macerated waste is discarded. According to the illustrated embodiment, green waste reservoir 134 may further define an auxiliary aperture 148 for dispensing a portion of waste into a reservoir for facilitating a fermentation process, as described in more detail below.

As explained briefly above, composting machine 100 may further include a composting portion 150 that includes one or more reservoirs for receiving and breaking down waste from anaerobic waste reservoir 132, green waste reservoir 134, and aerobic waste reservoir 136. Specifically, according to the illustrated embodiment, composting portion 150 may generally include a fermentation reservoir 152 for performing a fermenting process on a mixture including anaerobic waste. In addition, composting portion 150 may include a composting reservoir 154 that is generally configured for performing a composting process on a mixture including aerobic waste and/or green waste.

In general, it may be desirable to process anaerobic waste within fermentation reservoir 152 in order to reduce the risks associated with food-borne pathogens. As explained in more detail below, the fermentation process that occurs within fermentation reservoir 152 may neutralize the anaerobic waste to prevent risk of such pathogens. Notably however, green waste may also be processed within fermentation reservoir 152. Accordingly, green waste reservoir 132 may discard a portion of the green waste into fermentation reservoir 152 through auxiliary aperture 148. Aerobic waste may generally be deposited directly into composting reservoir 154 through discharge apertures 146 of green waste reservoir 134 and/or aerobic waste reservoir 136.

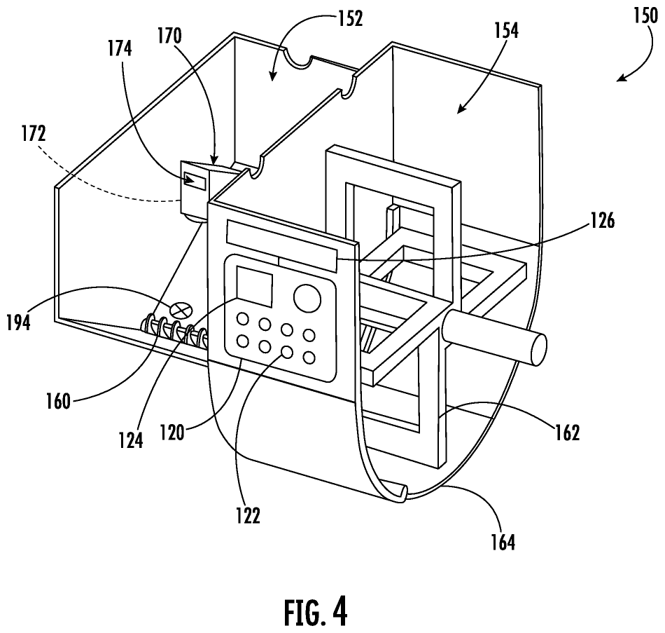

Referring now specifically to FIGS. 1 and 4, the interaction between fermentation reservoir 152 and composting reservoir 154 will be described in more detail according to an example embodiment. According to an example embodiment, fermented waste from fermentation reservoir 152 may generally be incorporated into composted waste within composting reservoir 154 after the fermentation process has been completed. Accordingly, a fermentation auger 160 may be positioned within fermentation reservoir 152 for selectively urging anaerobic waste into composting reservoir 154 after the fermentation process. In addition, a mixer 162 may be rotatably mounted within composting reservoir 154 for mixing the anaerobic and the aerobic waste and to facilitate the composting process.

In addition, a sliding or pivoting door 164 may be defined proximate a bottom of the composting reservoir 154 for selectively opening to drop composted waste into an output bin 166. In this regard, controller 126 may monitor the operation of weight sensing bars 142, augers 144, 160, mixer 162, and other components of composting machine 100 to facilitate a composting process and may dispense the compost material into output bin 166 at the end of the process. A user may then remove the compost from output bin 166 and use it for useful purposes, e.g., such as soil, fertilizer, etc.

Referring now generally to FIGS. 1, 4, and 5, the performance of the fermentation process within composting machine 100 will be described in more detail according to example embodiments of the present subject matter. In this regard, it may be undesirable to compost anaerobic waste, such as meat, bones, dairy, etc., in the presence of oxygen, as this may result in the issues with food-borne pathogens, maggots, pests, rodents, etc. Accordingly, composting techniques for anaerobic material often require the performance of a fermentation process which may neutralize pathogens and result in safe compost. In general, fermentation is the chemical breakdown of a substance by bacteria, yeasts, microbes, or other microorganisms. As explained in more detail below, aspects of the present subject matter are directed to the use of microbes to catalyze such a fermentation reaction, though the use of other fermentation catalysts are possible and within the scope of the present subject matter.

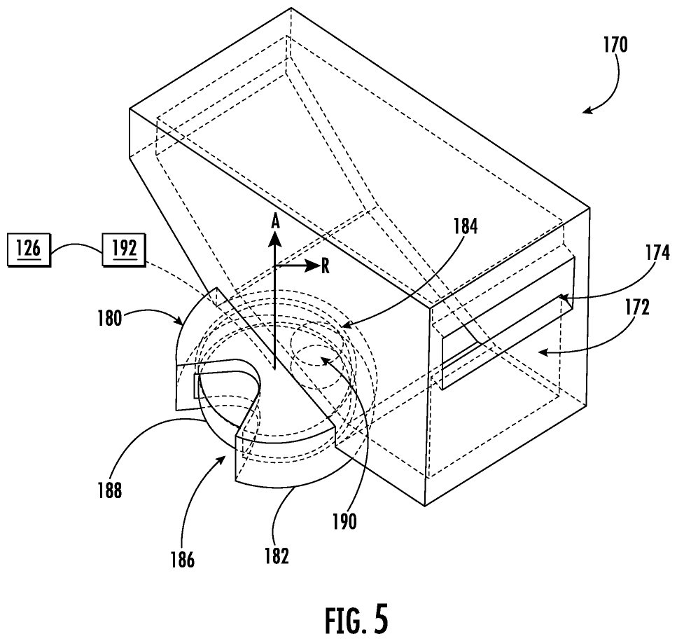

Specifically, as shown in FIG. 1, composting machine 100 includes a microbe dispensing device 170 is positioned at least partially above fermentation reservoir 152 for supplying microbes into fermentation reservoir 152 and facilitating the fermentation process. Specifically, referring also to FIG. 5, microbe dispensing device 170 may include a microbe reservoir 172 for receiving a microbe product (not shown). According to example embodiments, the microbe product includes pelletized microbes, though it should be appreciated that other fermentation catalysts may be used while remaining within the scope of the present subject matter. Microbe reservoir 172 may define a microbe supply opening 174 through which a user may fill microbe reservoir 172 with the microbe product periodically.

Microbe dispensing device 170 may further include a dispensing mechanism 180 for selectively depositing the microbe product into fermentation reservoir 152 to facilitate a fermentation process with the anaerobic waste (and/or the green waste). Although an exemplary dispensing mechanism 180 is described below, it should be appreciated that variations and modifications may be made while remaining within the scope of the present subject matter.

According to the illustrated embodiment, dispensing mechanism 180 is mounted to microbe reservoir 172 and includes a disk housing 182 that defines an intake opening 184 positioned under microbe reservoir 172 for receiving the microbe product under the force of gravity. In addition, disk housing 182 may define a discharge opening 186 that is positioned over fermentation reservoir 152. A dispenser disk 188 may be rotatably mounted within disk housing 182, wherein rotation of dispenser disk 188 may direct the microbe product through disk housing 182 between intake opening 184 and discharge opening 186.

Specifically, according to the illustrated embodiment, dispenser disk 188 may rotate about axis of rotation A and may define a pellet aperture 190 that passes through dispenser disk 182 along a direction parallel to the axis of rotation A. Specifically, pellet aperture 190 may be spaced apart from the axis of rotation A along a radial direction R. As illustrated in FIG. 5, when dispenser disk 182 is in an intake position, pellet aperture 190 may be aligned with intake opening 184 such that microbes may fill pellet aperture 190. In this regard, pellet aperture 190 may be sized to define a dosing volume of the microbe product. In this regard, a height and diameter of pellet aperture 190 may be sized to dispense a precise volume of microbe product for each turn of dispenser disk 188. Specifically, according to the illustrated embodiment, dispenser disk 188 is configured to dispense the dosing volume of the microbe product one time for every 360 degrees of rotation.

As shown schematically in FIG. 5, a motor 192 may be mechanically coupled to dispenser disk 188 for selectively rotating dispenser disk 188 to dispense the microbe product. In this regard, controller 126 may be in operative communication with motor 192 and may selectively operate motor 192 to facilitate a composting and/or fermentation process. Composting machine 100 may further include one or more weight sensors (not shown) that are configured for measuring the weight of anaerobic waste within fermentation reservoir 152. When the weight exceeds a predetermined threshold, controller 126 may operate motor 192 to dispense the microbe product and facilitate the fermentation process.

Notably, the fermentation process may generate a large amount of liquid nutrients or water. It may be desirable to extract this liquid from the fermented anaerobic waste prior to discharging the fermented anaerobic waste into composting reservoir 154. Accordingly, a wastewater discharge port 194 may be defined proximate a bottom of fermentation reservoir 152 and may be fluidly coupled to a liquid storage reservoir 196. During the fermentation process, controller 126 may automatically open wastewater discharge port 194 to allowed liquid to drain into wastewater reservoir 196. A user may subsequently extract the liquid from wastewater reservoir 196, e.g., for use as a liquid nutrient fertilizer.

As explained herein, aspects of the present subject matter are generally directed to a composting system that includes both aerobic and anaerobic composting systems integrated into a single machine. Specifically, the aerobic system may be designed to use an oxygenated space to breakdown commonly composted items, such as paper, cardboard, yard waste, food scraps, etc., which may be composted in the presence of oxygen. In addition, the anaerobic system may be designed to receive meat, bones, dairy, etc., in the absence of oxygen to permit proper composting and breakdown of the materials while minimizing the risk of pathogens.

Aspects of the present subject matter are directed to a microbe dispenser device that facilitates the performance of the anaerobic composting process. Specifically, the microbe dispenser may include a refillable reservoir and a motorized dispenser disk for consistent distribution of microbes into the anaerobic composting bin. The dispenser disk may feature an off-center hole, covered at the bottom and open at the top in its initial position, allowing for microbial intake. Upon a 180-degree rotation, the hole's orientation reverses, facilitating microbial dispensing. This mechanism enables the device to continually load and release microbes with each disk rotation, thereby facilitating the composting process.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A composting machine comprising:
a fermentation reservoir for holding anaerobic waste; and
a microbe dispensing device positioned at least partially above the fermentation reservoir, the microbe dispensing device comprising:
a microbe reservoir for receiving a microbe product; and
a dispensing mechanism for selectively depositing the microbe product into the fermentation reservoir to facilitate a fermentation process of the anaerobic waste.

2. The composting machine of claim 1, wherein the dispensing mechanism comprises:
a disk housing defining an intake opening positioned under the microbe reservoir and a discharge opening positioned over the fermentation reservoir; and
a dispenser disk rotatably mounted within the disk housing, wherein rotation of the dispenser disk directs the microbe product through the disk housing between the intake opening and the discharge opening.

3. The composting machine of claim 2, wherein the dispenser disk rotates about an axis of rotation and defines a pellet aperture spaced apart from the axis of rotation along a radial direction.

4. The composting machine of claim 3, wherein the pellet aperture is sized to define a dosing volume of the microbe product.

5. The composting machine of claim 2, wherein the dispenser disk is configured to dispense the microbe product one time for every 360 degrees of rotation.

6. The composting machine of claim 2, further comprising:
a motor mechanically coupled to the dispenser disk; and
a controller in operative communication with the motor for selectively rotating the dispenser disk to dispense the microbe product.

7. The composting machine of claim 1, wherein the microbe reservoir defines a microbe supply opening for filling the microbe reservoir with the microbe product.

8. The composting machine of claim 1, further comprising:
a wastewater discharge port defined proximate a bottom of the fermentation reservoir and being fluidly coupled to a liquid storage reservoir.

9. The composting machine of claim 1, further comprising:
one or more weight sensors for detecting a weight of the anaerobic waste; and
a controller in operative communication with the one or more weight sensors and being configured to:
obtain a weight of the anaerobic waste;
determine that the weight of the anaerobic waste exceeds a predetermined threshold; and
operate the microbe dispensing device to dispense the microbe product in response to determining that the weight of the anaerobic waste exceeds the predetermined threshold.

10. The composting machine of claim 1, wherein the microbe product comprises pelletized microbes.

11. The composting machine of claim 1, further comprising:
a composting reservoir for holding aerobic waste and the anaerobic waste after completion of the fermentation process, wherein a composting cycle is performed within the composting reservoir.

12. The composting machine of claim 11, further comprising:
an auger for selectively urging the anaerobic waste into the composting reservoir after completion of the fermentation process.

13. The composting machine of claim 11, further comprising:
a mixer rotatably mounted in the composting reservoir for mixing the anaerobic waste and the aerobic waste.

14. The composting machine of claim 11, further comprising:
an output bin for receiving both the anaerobic waste and the aerobic waste after the composting cycle.

15. The composting machine of claim 14, further comprising:
a door in bottom of the composting reservoir that is selectively opened to drop composted waste into the output bin.

16. The composting machine of claim 11, further comprising:
an anaerobic waste reservoir for feeding the anaerobic waste into the fermentation reservoir;
a green waste reservoir for feeding green waste into either the fermentation reservoir or the composting reservoir; and
an aerobic waste reservoir for feeding the aerobic waste into the composting reservoir.

17. A microbe dispensing device for a composting machine, the microbe dispensing device comprising:
a microbe reservoir positioned at least partially above a fermentation reservoir and being configured for receiving a microbe product; and
a dispensing mechanism for selectively depositing the microbe product into the fermentation reservoir to facilitate a fermentation process of anaerobic waste in the fermentation reservoir.

18. The microbe dispensing device of claim 17, wherein the dispensing mechanism comprises:
a disk housing defining an intake opening positioned under the microbe reservoir and a discharge opening positioned over the fermentation reservoir; and
a dispenser disk rotatably mounted within the disk housing, wherein rotation of the dispenser disk directs the microbe product through the disk housing between the intake opening and the discharge opening.

19. The microbe dispensing device of claim 18, wherein the dispenser disk rotates about an axis of rotation and defines a pellet aperture spaced apart from the axis of rotation along a radial direction.

20. The microbe dispensing device of claim 19, wherein the pellet aperture is sized to define a dosing volume of the microbe product and is configured to dispense the microbe product one time for every 360 degrees of rotation.
